(19) United States
(12) Patent Application Publication
(10) Pub. No.: US 2024/0278280 A1
(43) Pub. Date: Aug. 22, 2024

(54) ADJUSTABLE HANDLE

(71) Applicant: Telebrands Corp., Fairfield, NJ (US)

(72) Inventor: John Yeiser, Alpine, CA (US)

(21) Appl. No.: 18/111,436

(22) Filed: Feb. 17, 2023

(51) Int. Cl. B05B 15/63; B05B 1/30

(52) U.S. Cl. CPC B05B 15/63; B05B 1/3026

(57) ABSTRACT

An adjustable handle that may be used with, e.g., a hose, the adjustable handle including a body having a connecting member extending therefrom, a first end, a second end, and an interior channel extending from the first end to the second end; a grip having a central opening and a cavity for receiving the connecting member of the body to connect the body with the grip; and a grip position adjuster at least partially disposed in the cavity of the grip, the grip position adjuster including a button extending into the central opening of the grip, where adjustment of the grip position adjuster by depressing of the button of the grip position adjuster permits rotational movement of the grip from being locked a first position to being locked in a second position.

### TECHNICAL FIELD

The present application relates to an adjustable handle, e.g., for attachment to a hose, particularly an adjustable handle including features that allow a user to hold the handle in a variety of configurations.

### BACKGROUND OF THE INVENTION

Hoses are commonly used in many different fields, such as for watering plants, cleaning automobiles, or putting out fires. However, the means by which to operate such hoses, i.e., hose handles, are often not taken into account when designing a hose. As seen in many presently available conventional hoses, the focus of improvement is usually on the hose itself or the nozzle that discharges the fluid, as opposed to the hose handle. However, such focus is detrimental to the users of the hoses. For example, the aforementioned tasks of watering plants, cleaning automobiles or putting out fires may last for an extended period, e.g., minutes to hours. Consequently, users may tire from such activities. Such exhaustion is further exacerbated by any discomfort from holding the hose handle, which may not be designed to be ergonomic due to the primary focus on other aspects of the hose. Further, users may desire to grip the hose handle in different manners from each other. As such, the default hose handle produced by a manufacturer may not always conform ergonomically to a particular user's desired grip. Thus, there needs to be an improvement in hose handles to provide a more ergonomic grip to various users.

### SUMMARY OF THE INVENTION

In general, in one aspect, the invention features an adjustable handle including a body having a connecting member extending therefrom, a first end, a second end, and an interior channel extending from the first end to the second end; a grip having a central opening and a cavity for receiving the connecting member of the body to connect the body with the grip; and a grip position adjuster at least partially disposed in the cavity of the grip, the grip position adjuster including a button extending into the central opening of the grip, where adjustment of the grip position adjuster by depressing of the button of the grip position adjuster permits rotational movement of the grip from being locked a first position to being locked in a second position.

Implementations of the invention may include one or more of the following features. The grip position adjuster may further include one or more side protrusions capable of assisting the grip in locking in the first position or the second position. The first position of the grip may be parallel to the channel of the body, and the second position of the grip may be perpendicular to the channel of the body. The second end of the body may be configured for reversible connection to a hose capable of providing a fluid such the fluid traverses the body from the first end to the second end via the channel.

The adjustable handle may further include a nozzle that is reversibly attached to the first end of the body, the nozzle being configured to discharge a fluid that exits from the first end of the body. The nozzle may include one or more spray modes permitting a user of the adjustable handle to select a manner in which to discharge the fluid from the nozzle. The nozzle may include a rotational mechanism that allows the user of the adjustable handle to select the spray mode by operating the rotational mechanism. The nozzle may include one or more discharge openings that discharge the fluid according to the spray mode selected by the user. The body may include a valve that controls the flow of a fluid from the second end of the body to the first end of the body. The valve may include a selection member that is operable by a user of the adjustable handle to block the fluid from flowing from the second end of the body to the first end of the body.

In general, in another aspect, the invention features a system for transporting a fluid, the system including a hose and an adjustable handle that is reversibly connected to the hose, the adjustable handle including a body having a connecting member extending therefrom, a first end, a second end, and an interior channel extending from the first end to the second end; a grip having a central opening and a cavity for receiving the connecting member of the body to connect the body with the grip; and a grip position adjuster at least partially disposed in the cavity of the grip, the grip position adjuster including a button extending into the central opening of the grip, where adjustment of the grip position adjuster by depressing of the button of the grip position adjuster permits rotational movement of the grip from being locked a first position to being locked in a second position.

Implementations of the invention may include one or more of the following features. The grip position adjuster may further include one or more side protrusions capable of assisting the grip in locking in the first position or the second position. The first position of the grip may be parallel to the channel of the body, and the second position of the grip may be perpendicular to the channel of the body. The second end of the body may be configured for reversible connection to the hose capable of providing a fluid such the fluid traverses the body from the first end to the second end via the channel.

The adjustable handle may further include a nozzle that is reversibly attached to the first end of the body, the nozzle being configured to discharge a fluid that exits from the first end of the body. The nozzle may include one or more spray modes permitting a user of the adjustable handle to select a manner in which to discharge the fluid from the nozzle. The nozzle may include a rotational mechanism that allows the user of the adjustable handle to select the spray mode by operating the rotational mechanism. The nozzle may include one or more discharge openings that discharge the fluid according to the spray mode selected by the user. The body may include a valve that controls the flow of a fluid from the second end of the body to the first end of the body. The valve may include a selection member that is operable by a user of the adjustable handle to block the fluid from flowing from the second end of the body to the first end of the body.

### BRIEF DESCRIPTION OF THE DRAWINGS

The aforementioned and other aspects, feature and advantages can be more readily understood from the following detailed description with reference to the accompanying drawings wherein:

FIG. 1 shows a perspective view of an adjustable handle that includes a nozzle, a body and a grip, in which the grip is moved to a first position with respect to the body, according to an embodiment of the present application;

FIG. 2 shows a perspective view of the adjustable handle, in which the grip is moved to a second position with respect to the body, according to an embodiment of the present application;

FIG. 3 shows a side view of the adjustable handle, in which the grip is moved to the first position with respect to the body, according to an embodiment of the present application;

FIG. 4 shows a top view of the adjustable handle, in which the grip is moved to the first position with respect to the body, according to an embodiment of the present application;

FIG. 5 shows a bottom view of the adjustable handle, in which the grip is moved to the first position with respect to the body, according to an embodiment of the present application;

FIG. 6 shows a top view of the adjustable handle, in which the grip is moved to the second position with respect to the body, according to an embodiment of the present application;

FIG. 7 shows a front view of the adjustable handle, in which the grip is moved to the first position with respect to the body, according to an embodiment of the present application;

FIG. 8 shows a back view of the adjustable handle, in which the grip is moved to the first position with respect to the body, according to an embodiment of the present application;

FIG. 9 shows a side view of the body, according to an embodiment of the present application;

FIG. 10 shows a bottom view of the body, according to an embodiment of the present application;

FIG. 11 shows a front view of the body when a valve connected to the body is in an open position, according to an embodiment of the present application;

FIG. 12 shows a front view of the body when a valve connected to the body is in a closed position, according to an embodiment of the present application;

FIG. 13 shows a top view of the grip, according to an embodiment of the present application;

FIG. 14 shows a perspective view of the grip, according to an embodiment of the present application;

FIG. 15 shows side view of an internal portion of a first half of the grip, according to an embodiment of the present application;

FIG. 16 shows a perspective view of an internal portion of a first half of the grip, according to an embodiment of the present application;

FIG. 17 shows a front view of a mode adjuster that is operable by a user of the adjustable handle to facilitate the movement of the grip from the first position to the second position or vice versa, according to an embodiment of the present application;

FIG. 18 shows a side view of the body being connected to a first half of the grip, according to an embodiment of the present application;

FIG. 19 shows a close-up perspective view of the relationship between the body, a first half of the grip, and the mode adjuster, when the mode adjuster is in the default position, according to an embodiment of the present application;

FIG. 20 shows a close-up perspective view of the relationship between the body, a first half of the grip, and the mode adjuster, when the mode adjuster is in the compressed position, according to an embodiment of the present application;

FIG. 21 shows a user holding the adjustable handle in the first position, according to an embodiment of the present application;

FIG. 22 shows a user holding the adjustable handle in the first position, according to another embodiment of the present application;

FIG. 23 shows a user holding the adjustable handle in the second position, according to an embodiment of the present application; and

FIG. 24 shows a user holding the adjustable handle in the second position, according to another embodiment of the present application.

### DETAILED DESCRIPTION OF THE PREFERRED EMBODIMENTS

In describing preferred embodiments illustrated in the drawings, specific terminology is employed herein for the sake of clarity. However, this disclosure is not intended to be limited to the specific terminology so selected and it is to be understood that each specific element includes all technical equivalents that operate in a similar manner. In addition, a detailed description of known functions and configurations is omitted from this specification when it may obscure the inventive aspects described herein.

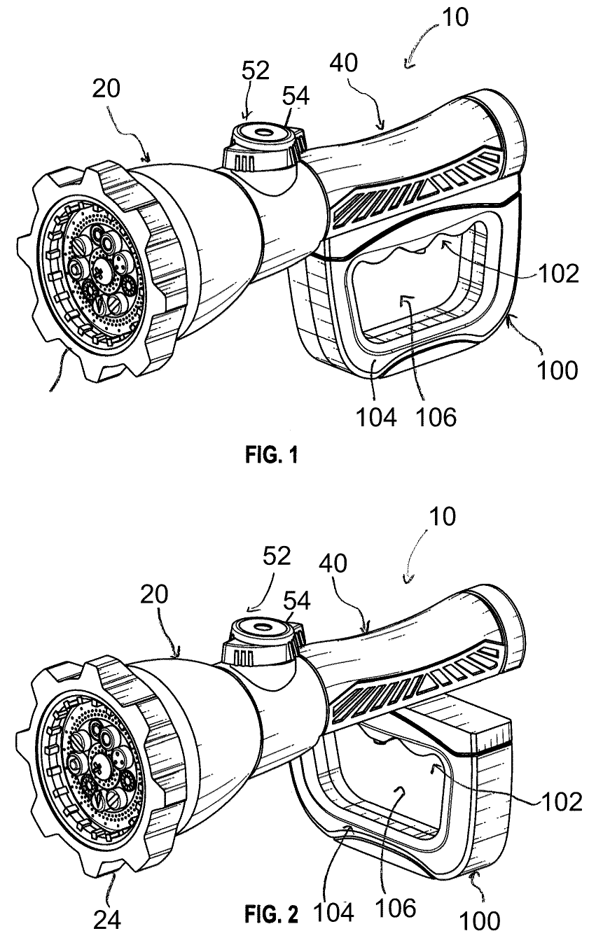

FIGS. 1 and 2 illustrate a perspective view of an adjustable handle 10, e.g., that may be removably attached to a hose (not shown). The hose may be any elongated tube that includes a channel therein for transporting water from a first end of the hose to a second end of the hose. Such hose may be used in a domestic setting, e.g., at home in the garden to water grass or plants, a commercial setting, e.g., in a carwash to clean cars, or a public setting, e.g., by firefighters to put out fires. The first end of the hose may be removably attached to a fluid source, such as a faucet, while the second end of the hose may be removably attached to the handle 10. The handle 10 may modify the flow of water provided by the hose as it exits the handle 10. Such modification may be based on a spray configuration of the nozzle of the handle 10 as set by the user. In addition to modifying the flow of water, the handle 10 also provides the user with multiple configurations for holding handle 10, such that the user may switch to a different configuration based on the user's desired comfort.

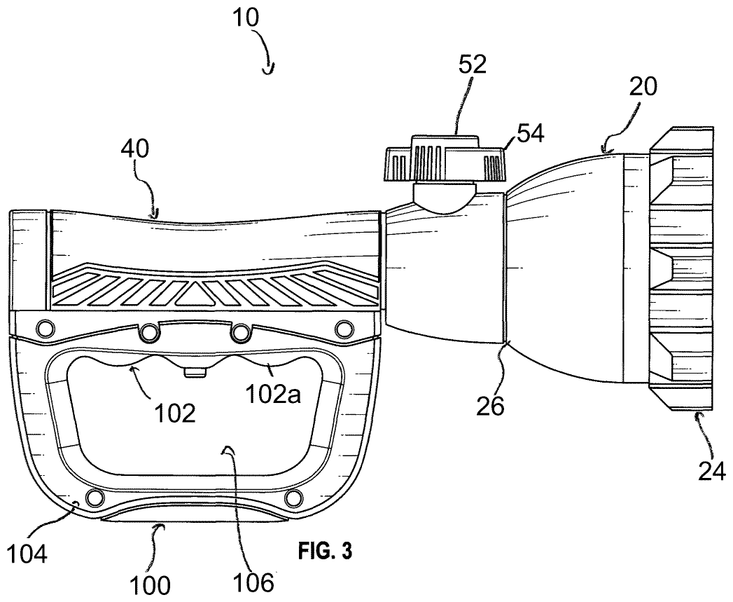

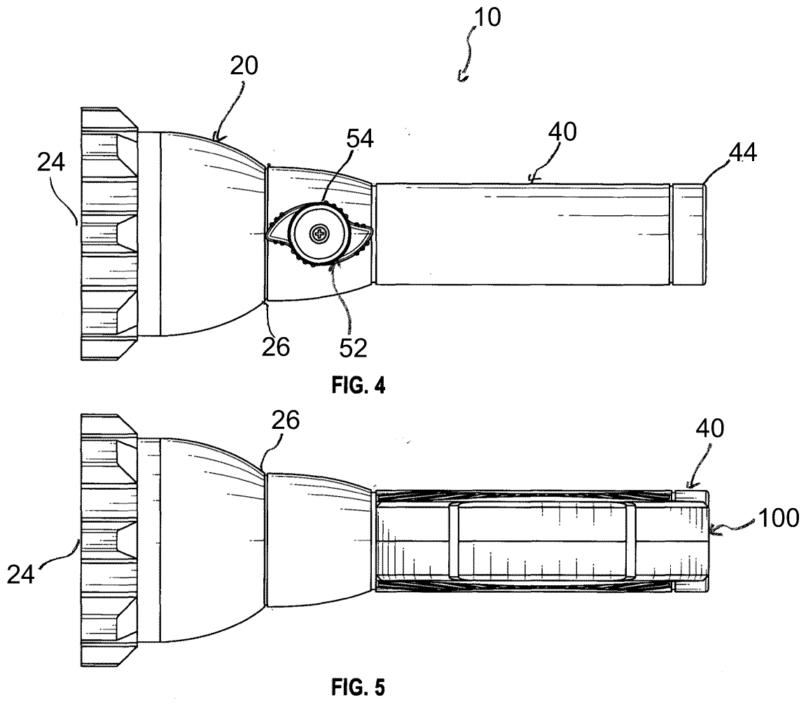

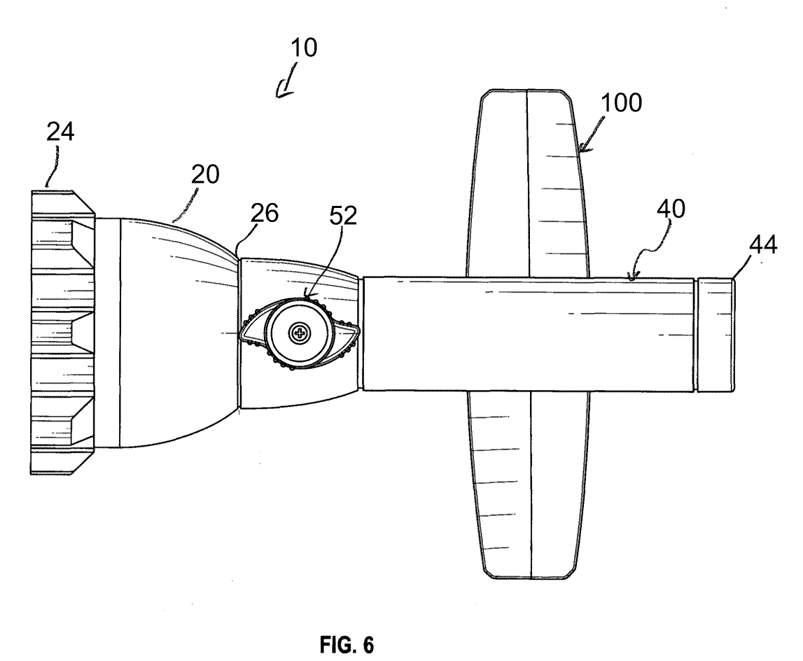

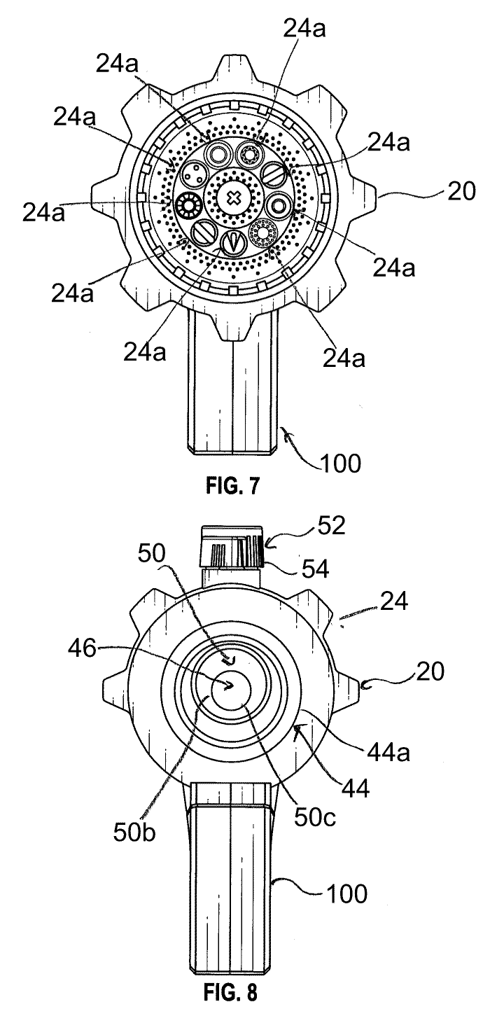

As shown in FIGS. 1-8, the handle 10 may include a body 40 connected to both a grip 100 and a nozzle 20.

### Handle Body

The body 40 may include a bottom side 58 that, for example, may be a continuously flat and smooth surface. The bottom side 58 includes a connecting member 60 that is configured to connect the body 40 to the grip 100. The connecting member 60 also includes a series of layers that cooperate with the grip 100, so as to allow the grip 80 to move to one or more positions with respect to the connecting member 100. The connecting member 60 includes a first layer 62, a second layer 64 that is disposed below the first layer 62, a third layer 66 that is disposed below the second layer 64, and a fourth layer 68 that is disposed below the third layer 66. In one exemplary embodiment, both the first layer 62 and the second layer 64 include a cylindrical shape, in which the radius of the first layer 62 is less than the second layer 64. In another exemplary embodiment, both the third layer 66 and the fourth layer 68 include a cylindrical shape, in which the radius of the third layer 66 is less than the second layer 64. In yet another exemplary embodiment, the first layer 62 and the third layer 66 have similar or same radius, and the second layer 64 and the fourth layer 68 have similar or same radius. The connecting member 60 also includes a cavity 70 that extends from the bottom side 58 to the fourth layer 68, such that the cavity 70 includes a closed end at the bottom side 58 and an open end at the fourth layer 68. In one exemplary embodiment, the cross-section of the cavity 70 is a curved shape, e.g., circle or oval. In addition, a space 72 may be present, such that the space 72 divides the third layer 66 into a first third layer portion 66a and second third layer portion 66b. Likewise, the space 72 may also divide the fourth layer 68 into a first fourth layer portion 68a and a second fourth layer portion 68b, such that the first fourth layer portion 68a includes an interior wall 68a-1 that faces the space 72 and the second fourth layer portion 68b includes an interior wall 68b-1 that faces the space 72 and is opposite the interior wall 68a-1. The space 72 is connected to the cavity 70, such that the space 72 is a part of or integral to the cavity 70.

A mode adjuster 74 is held in the cavity 70. In one exemplary embodiment, the mode adjuster 74 is freely held in the cavity 70, such that the mode adjuster 74 is movable independent of the movement of the connecting member 60. As shown in FIG. 17, the mode adjuster 74 includes a button member 76 that in turn includes a button body 78 and one or more protrusions 80. The button body 78 includes a top side 78a and a bottom side 78b. Each of the one or more protrusions 80 extends from the button body. In addition, each of the one or more protrusions 80 includes a top side 80a, a bottom side 80b, a first side 80c, a second side 80d and a front side 80e. In addition, the mode adjuster 74 also includes a spring support 82 that extends from the top side 78a of the button body 78.

The mode adjuster 74 also includes a spring member 84 that is connected to the button body 78. The spring member 84 may include a first end 84a and a second end 84b. The spring member 84 may be any object or element that, after being compressed by an external force, expands itself automatically after the external force is no longer applied. In one exemplary embodiment, the spring member 84 is coil spring that is of a compression type, i.e., configured to compress when force is applied to the coil spring. In a default position of the button member 76, the spring member 84 is in its natural state. However, by pushing the button member 76 vertically into the spring member 84, i.e., into a compressed position, the spring member 84 contracts and becomes temporarily compressed. In another exemplary embodiment, the button body 78 includes a spring support 82 disposed on the top side 78a. Such spring support 82 locks the spring member 84 to the button body 78. For example, such lock may be permanent, e.g., via adhesive, such that the spring member 84 is permanently attached to the spring member 84. In another example, the lock may be temporary or reversible, such that the force, e.g., via frictional forces due to, for example, one or more hooks, that maintains the spring member 84 attached to the spring support 82 of the button member 76 is capable of being overcome by the user simply pulling the spring member 84 away from the spring support 82 of the button member 76.

The cavity 70 and the space 72 are configured to conform to the dimensions of the mode adjuster 74, such that the button member 76 and/or spring member 84 of the mode adjuster 74 are capable of being held within the cavity 70, while simultaneously being able to move independently without difficulty, such as, for example, due to possible frictional forces between the button 76 (or spring member 84) and an interior surface formed from the layers 62-68 of the connecting member 60. As such, even though the space 72 is present (such that there is a space between the third layer portion 66a and the third layer portion 66b and a space between the fourth layer portion 68a and the fourth layer portion 68b), the third layer portions 66a, 66b and the fourth layer portions 68a, 68b nonetheless include a structure to accommodate the button member 76.

For example, as shown in FIG. 17, the button body 78 of the button member 76 includes a cylindrical shape and the spring member 84 is a coil, i.e., also having a cylindrical shape, that includes a similar radius to the button body 78. As such, the cavity 70 may also be configured to have a cylindrical shape with a radius that is slightly larger than the button body 78 and/or the spring member 84, such that the cavity 70 is capable of accommodating the button body 78 and/or the spring member 84, while allowing the button body 78 and/or the spring member 84 to move, e.g., vertically, within the cavity 70. It should be noted that, because the cavity 70 extends towards the fourth layer 68 and is integral with the space 72, the third layer portions 66a, 66b also include curved surfaces to account for the curvature of the button body 78. Likewise, the fourth layer portions 68a, 68b also include curved surfaces to account for the curvature of the button body 78. In addition, the space 72 is also configured to accommodate the first protrusion 80 and the second protrusion 82. The first protrusion 80 is disposed between the third layer portion 66a and the third layer portion 66b. The first protrusion 80 is also disposed between the fourth layer portion 68a and the fourth layer portion 68b. Likewise, the second protrusion is disposed between the third layer portion 66a and the third layer portion 66b. The second protrusion 82 is also disposed between the fourth layer portion 68a and the fourth layer portion 68b.

In one exemplary embodiment, the bottom side 58 of the body 40 includes a holding protrusion 58a that aids in maintaining the spring member 84 in a straight and/or vertical position. This is advantageous when the spring member 84 is a coil-type spring because when a coil-type spring is compressed, the coil-type spring tends to bend perpendicularly to the compressive force. Such bending is undesirable because it is possible to damage the coil-type spring over time. As such, the holding protrusion 58a may maintain the spring member 84 in a straight and/or vertical position, such that the spring member 84 does not bend perpendicularly when it is compressed. Such holding protrusion 58a may be inserted into an opening located on the first end 84a of the coil-type spring. In addition, as mentioned previously, the button body 78 of the mode adjuster 74 includes a spring support 82, such that the spring support 82 locks the spring member 84 to the button body 78. Such locking by the spring support 82 also affords the same advantages as the holding protrusion 58a, as it prevents the spring member 84 from bending perpendicularly. As such, by having the spring support 82 cooperate with the holding protrusion 58a to maintain the spring member 84 in a straight and/or vertical position, the spring member 84 is capable of avoiding damage from perpendicular bending.

### Handle Grip

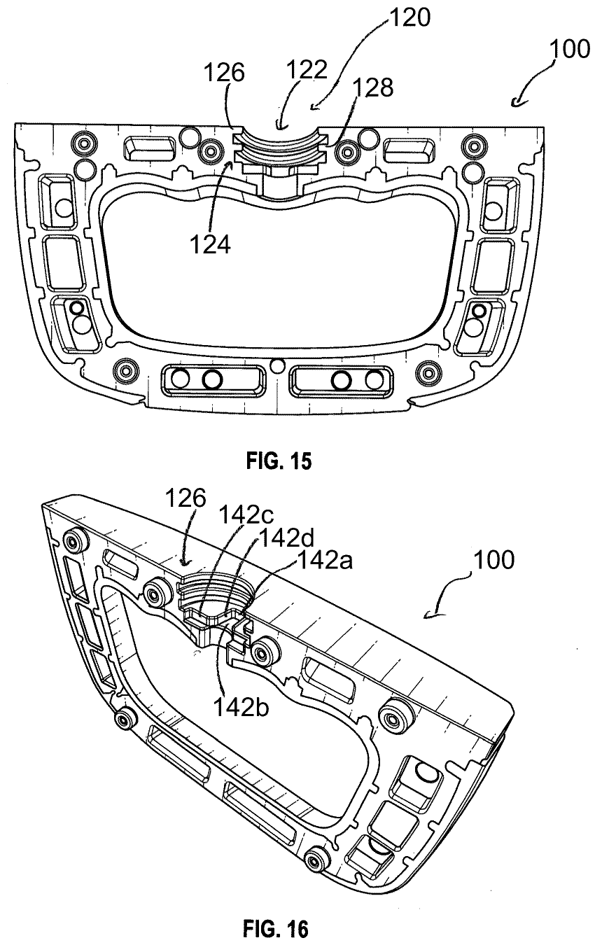

The grip 100 may be configured to allow the user to comfortably hold the handle 10. The grip 100 includes a first holding portion 102 and a second holding portion 104 that is separated by a grip opening 106 that allows the user to insert his or her fingers into the grip opening 106 in order to hold the handle 10. The first holding portion 102 includes a series of grooves 102a that conform to a user's fingers to provide an ergonomically comfortable grip for the user when the user holds the handle 10. The second holding portion 104 may also be utilized by a user as an alternate holding position for holding the handle 10. In one exemplary embodiment, the second holding portion 104 may include a smooth surface, e.g., users may not be comfortable with grooved surfaces. As shown by FIGS. 15 and 16, the grip 100 is capable of being divided into one or more pieces. For example, the grip 100 is divided into a first half and a second half. In one embodiment, the first half of grip 100 is substantially identical to the second half of grip 100. However, in another embodiment, there may be minor differences between the first half and the second half, such as the first half includes one or more prongs to be attached to the second half. Such division may be the result of a manufacturing process in which the first half and the second half are initially produced separately but later combined together in the end product, i.e., adjustable handle 10.

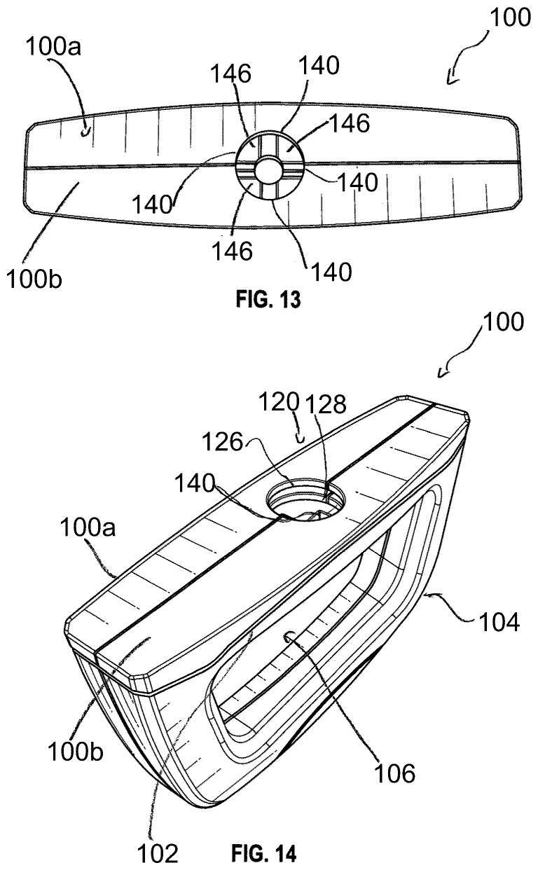

As shown in FIGS. 13 and 14, the grip 100 further includes a receiving member 120, which is configured to mate with the connecting member 60, such that the grip 100 becomes movably attached to the body 40. The receiving member 120 includes a cavity section 122 and a button rest section 140. The cavity section 122 includes a first end 122a that is open and a second end 122b that is connected to the button rest section 140. The cavity section 122 further includes an interior wall 124 that includes a first protrusion 126 that extends inwardly, such that the first protrusion 126 is disc-shaped, and a second protrusion 128 that also extends inwardly, such that the second protrusion 128 is also disc-shaped. The first protrusion 126 may be spaced from the second protrusion 128 by a predetermined distance. The second protrusion 128 may, in turn, be spaced from the button rest section 140 by a predetermined distance. The button rest section 140 is configured to hold the button member 76 of the mode adjuster 74 in one or more locked positions. The button rest section 140 includes one or more chambers 142 and an aperture 144. For example, each chamber may include a back wall 142a, a bottom wall 142b, a first side wall 142c, and a second side wall 142d, such that a single chamber 142 forms an open container to receive a protrusion 80. Between each chamber 142 is a surface 146 that may be a flat, smooth surface having an elevation level equivalent to the top of at least one of the back wall 142a, the first side wall 142c, and the second side wall 142d. The aperture 144 is an opening that is disposed in the center of the button rest section 140, such that the aperture 144 is configured to receive the bottom side 78b of the button body 78.

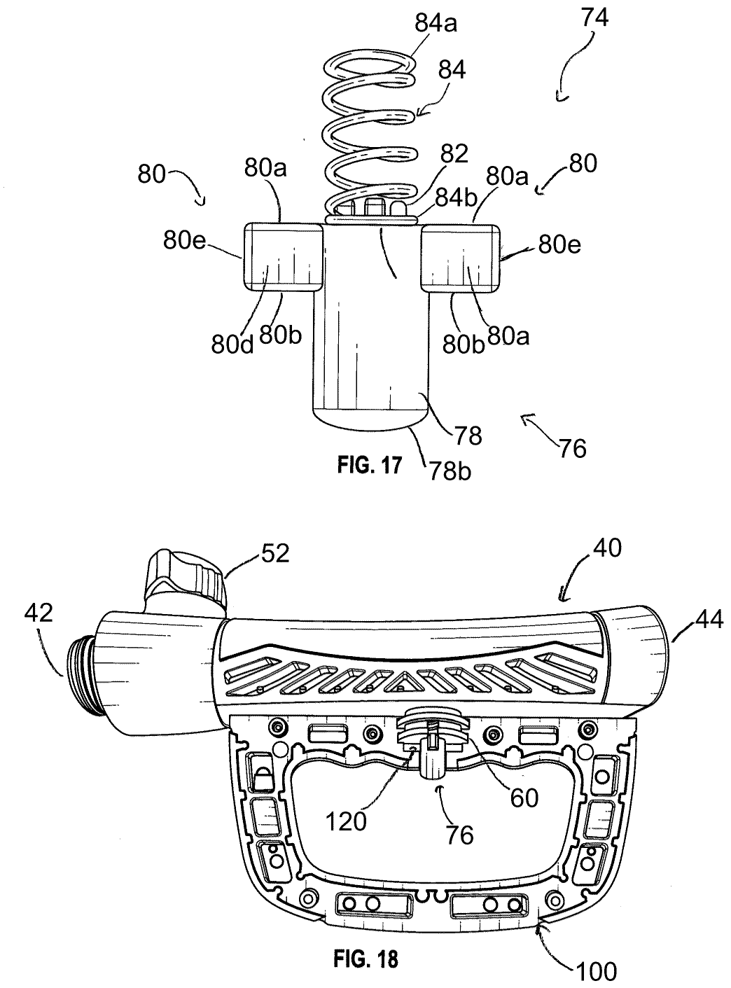

As shown in FIG. 18, the first protrusion 126 wraps around the first layer 62 of the connecting member 60, while the second protrusion 128 wraps around the third layer 66 of the connecting member 60. As such, the second layer 64 of the connecting member 60 is disposed in the space between the first protrusion 126 and the second protrusion 128. Likewise, the fourth layer 68 of the connecting member 60 is disposed in the space between the second protrusion 128 and the button rest section 140. Due to such configuration, the receiving member 120 (and by extension the grip 100) becomes rotatably interlocked with the connecting member 60 (and by extension the body 40), such that the grip 100 is capable, under certain conditions, of rotating with respect to the body 40 (while remaining connected to the body 40). Such conditions may be determined by the mode adjuster 74. As discussed above, the mode adjuster 74 is held in both the cavity 70 of the connecting member 60 and the button rest section 140 of the receiving member 120.

### Rotation and Locking Mechanism of Handle Grip

As shown in FIG. 19, when the mode adjuster 74 is in the default position, the spring member 84 pushes the button 76 downward towards the chamber 142, where the bottom side 80b of a protrusion 80 rests upon the bottom wall 142b of a chamber 142. However, the first side 80c and the second side 80d of the protrusion 80 have a height greater than the first side wall 142c and the second side wall 142d, respectively, such that the first side 80c and the second side 80d still remain in physical contact, e.g., held between, with the interior wall 68a-1 of the fourth layer portion 68a and the interior wall 68b-1 of the fourth layer portion 68b. As a consequent of this configuration, in the case where the user attempts to rotate the grip 100 when the mode adjuster 74 is in the default position, the user is unable to perform the rotation. In other words, the grip 100 is locked in a first position to the body 40. The reason for the inability of the user to perform such rotation is due to the interactions among the connecting member 60, the mode adjuster 74, and the receiving member 120. In other words, when the user attempts to rotate the grip 100, the first side wall 142c of the chamber 142 pushes the first side 80c of the protrusion 80. Normally, such action would also cause the rotation of the mode adjuster 74. However, the protrusion 80 is also held between the interior wall 68a-1 of the fourth layer portion 68a and the interior wall 68b-1 of the fourth layer portion 68b, which causes the protrusion (and by extension the mode adjuster 74) to remain in a non-moving, e.g., static or locked, position. As such, the connecting member 60 (via the fourth layer 68) blocks the rotation of protrusion 80 and, indirectly, the grip 100, thereby maintaining the grip 100 in a first position with respect to the body 40.

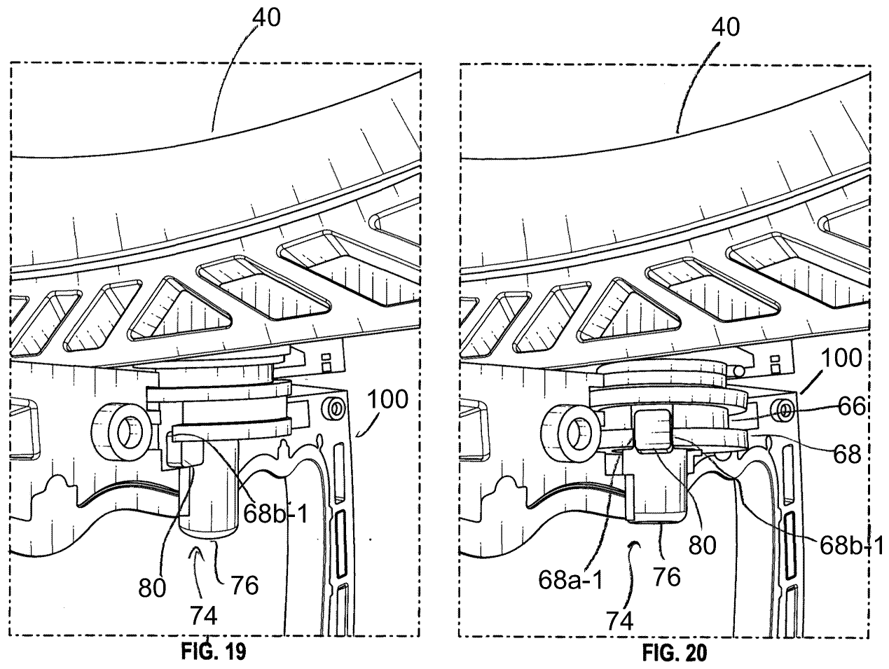

As shown in FIG. 20, to allow rotation of the grip 100, the user pushes the button member 76 vertically at a predetermined distance into a compressed position from the default position, such that the spring member 84 becomes compressed. Such action causes the protrusion 80 to be lifted towards the bottom side 58 into the space 72, to the point where the protrusion 80 is held entirely within the connecting member 60, i.e., between the third layer portion 66a and the third layer portion 66b as well as between the fourth layer portion 68a and the fourth layer portion 68b. Due to the fact that protrusion 80 is no longer in contact with the first side wall 142c and the second side wall 142d of the chamber 142 of the button rest section 140, the protrusion 80 no longer prevents the rotation of the grip 100. When the user rotates the grip 100 at a predetermined distance away from the chamber 142, e.g., a first chamber 142, the bottom side 80b of the protrusion 80 comes into contact with the surface 146, which assists in maintaining the protrusion 80 in a position entirely within the space 72 of the connecting member 60. As such, the user is no longer required to maintain his or her finger on the button member 76 and may focus on the rotation of the grip 100 instead. When the grip 100 rotates to a second chamber 142 that is the next immediate chamber 142 with respect to the first chamber 142, e.g., perpendicular to the first chamber 142, the force of the spring member 84 (no longer constrained by the surface 146) causes the protrusion 80 to drop down into the second chamber 142, e.g., snapped into place, such that the grip 100 is now locked in a second position. In one exemplary embodiment, the chambers 142 that are parallel from each other form a set that corresponds a particular locked position. In another exemplary embodiment, the user may rotate the grip 100 in 360 degrees (in either direction, clockwise or counter-clockwise) by simply maintaining the button member 76 is a compressed position.

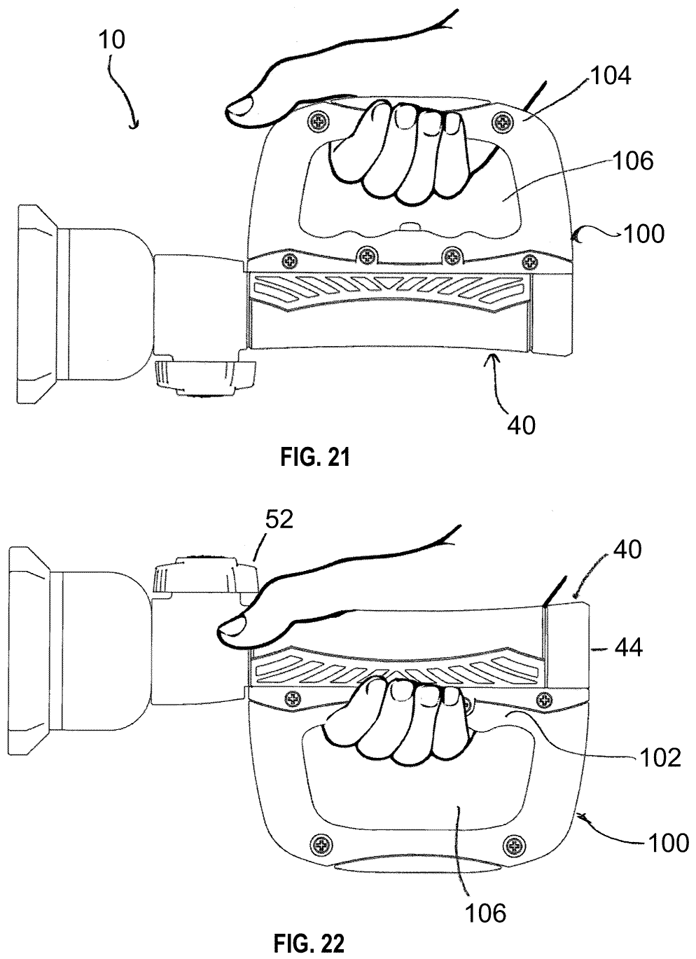

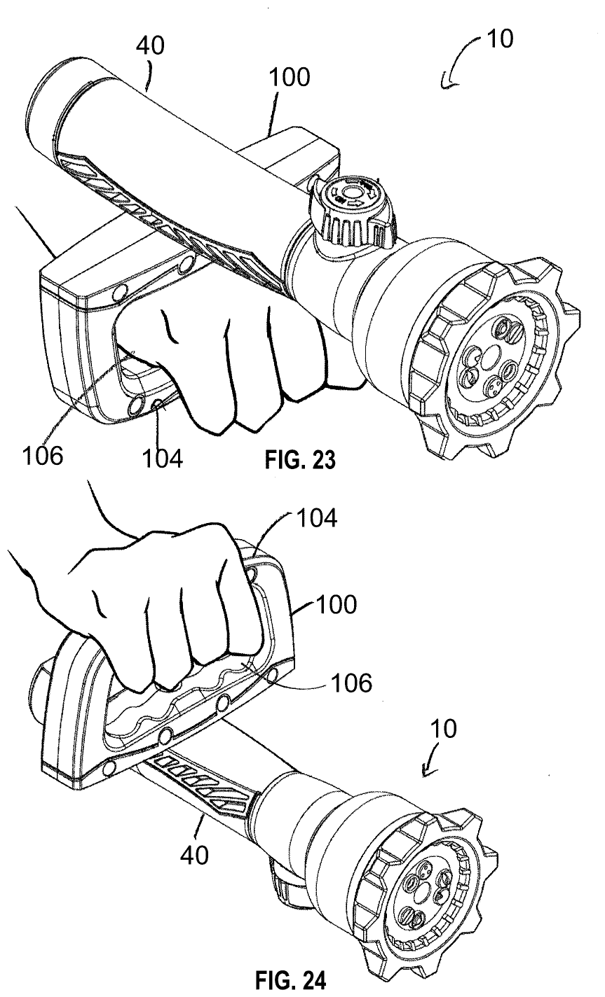

Due to the aforementioned configurations, the user may operate to adjust the grip 100 to move the grip 100 from being locked in a first position to being locked in a second position or vice versa. In a first position, the grip 100 may be parallel to the body 40 as shown in FIG. 1. In a second position, the grip 100 may be perpendicular to the body 40 as shown in FIG. 2. An example of an advantage of having the grip 100 move between first and second positions is that a user is capable of selecting the manner in which to hold the handle 10 that is most comfortable to the user. In other words, the user is not required to hold the handle 10 in one set manner. Instead, if the user feels tired of holding the handle 10 with the grip set in a first position, as shown in FIGS. 21 and 22, the user may rotate the grip 100 to set it in a second position, as shown in FIGS. 23 and 24.

More specifically, as shown in FIG. 21, in the first position, the user may insert his or her fingers through the opening 106 of the grip 100 to grasp the second holding portion 104 of the grip 100, with the result being that the handle 10 will hang below the hand. As shown in FIG. 22, also in the first position, the user may insert his or her fingers through the opening 106 of the grip 100 to grasp the first holding portion 102 along with the body 40 (between the valve 52 and the second end 44 of the body 40). As shown in FIG. 23, in the second position, the user may insert his or her fingers through the opening 106 of the grip 100 to grasp the second holding portion 104 of the grip 100, with the result being that the handle 10 will hang over the user's hand. As shown in FIG. 24, also in the second position, the user may insert his or her fingers through the opening 106 of the grip 100 to grasp the second holding portion 104 of the grip 100, with the result being that the handle 10 will hang below the user's hand.

### Handle Nozzle

The nozzle 20 is capable of discharging fluid that flows through the body 40. The nozzle 20 comprises a nozzle body 22 and a nozzle face 24 that is rotatably attached to the nozzle body 22. The nozzle face 24 includes one or more discharge openings 24a that release fluid in a specific manner depending on a discharge mode set by the user. In one exemplary embodiment, the fluid is discharged from a single discharge opening 24a. In another exemplary embodiment, the fluid is discharged from a plurality of discharge openings 24a. In yet another exemplary embodiment, the fluid is discharged from all of the discharge openings 24a. As stated previously, the nozzle face 24 is rotatable with respect to the nozzle body 22. By rotating the nozzle face 24 along a predetermined length, the user is capable of selecting the discharge mode of the nozzle 20.

In one exemplary embodiment, the user is capable of determining which spray mode to utilize based on markings on the nozzle 20. For example, the markings may include descriptive words, such as, but not limited to soaker, flat, vertical, shower, cone, fan, center, jet, or mist. Rotating the nozzle face 24 to soaker may cause large amounts of fluid to be discharged, which is useful for quickly watering plants in a large area. Rotating the nozzle face 24 to flat may cause fluid to be discharged in a wide (horizontal-wise) but narrow (vertical-wise) manner, which is useful for covering a large but narrow area, e.g., row of edging plants. Rotating the nozzle face 24 to vertical may cause the fluid to be discharged in a vertical manner. Rotating the nozzle face 24 to shower may cause fluid to be discharged softly in a spread-out manner (horizontally and vertically), which is useful for watering most plants without over-watering them. Rotating the nozzle face 24 to cone may cause a ring of fluid to be discharged, which is useful for watering plants arranged in a circular manner, e.g., ring. Rotating the nozzle face 24 to fan may cause the fluid to be discharged in a precise straight-forward manner, which is useful for situations requiring control of the discharge from the handle 10. Rotating the nozzle face 24 to center may cause the fluid to be discharged in a precise straight-forward manner, which is useful for situations requiring control of the fluid discharge from the handle 10. Rotating the nozzle face 24 to jet may cause the fluid to be discharged at a powerful rate, which is useful for clearing debris or cleaning automobiles. Rotating the nozzle face 24 to mist may cause the fluid to be discharged in a haze-like manner, which is useful for providing water to plants that require humidity or little water.

It should be noted that each of the discharge openings 24a may have a different cross-sectional shape depending on the function provided by the discharge openings 24a in connection with the aforementioned spray modes. Further, it should also be noted that, when the user selects a particular spray mode, not all of the discharge openings 24a may be actively discharging fluid. For example, in the case that a user selects jet as the spray-mode setting, a first set of discharge openings 24a may be in the active position, such that they facilitate the discharge of fluid in accordance with the jet spray mode setting. On the other hand, the remaining second set of discharge openings 24a that do not correspond to the jet spray-mode setting may, instead remain in the inactive position, in which they do not facilitate the discharge of any fluid.

The nozzle body 22 may include a rear end 26 that includes a rear opening. The rear opening may have a cross-sectional shape corresponding to any shape, e.g., a curved shape, such as a circle or an oval. A channel or fluid path is present from the rear opening to one or more of the discharge openings 24a. It should be noted that such fluid path is not required to be a straightforward path, and may instead be a complex path, e.g., maze or labyrinth. Such non-straightforward and complicated path may be configured to further generate or increase pressure in the fluid as it flows through the nozzle body 22 from the rear end 26 to one or more of the discharge openings 24a. Increasing the pressure of the fluid provides several advantages to one or more of the discharge openings 24a. One set of discharge openings 24a may benefit from the increased pressure because their main function is to discharge fluid over a great distance, e.g., the user may desire to perform cleaning of a surface that is high off the ground or a firefighter may want to have the fluid reach the upper level floors. Another set of discharge openings 24a may benefit from the increased pressure because their main function is to discharge fluid at a high velocity, e.g., the user may be attempting to clean off dirt or grime from a car that is difficult to remove thereby requiring large amount of force in the fluid discharge.

The nozzle 20 is capable of being removably attached to the body 40. Such flexibility allows the user to switch the nozzle 20 to a different type of nozzle, according to the desires of the user. For example, the nozzle 20 may be obsolete due to a newer model being introduced into the market or may be worn-out from continuous use over a long period of time. As such, the user may wish to substitute the nozzle 20 with a different model, a newer model, or a new version of the same model. To removably connect the nozzle 20 to the body 40, the rear end 26 may include a threaded surface. For example, such threaded surface may be a female threaded surface that is configured to receive a male threaded surface of the body 40. In such a case, the female threaded surface may interlock with the male threaded surface in order to lock the nozzle 20 to the body 40.

### Additional Fluid Flow and Restriction Aspects

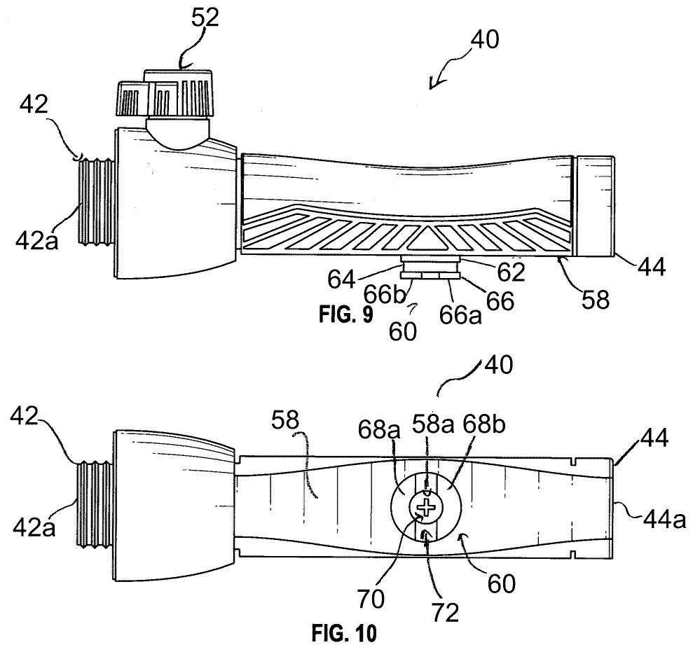

As shown in more detail in FIGS. 9-12, the body 40 of handle 10 may have an elongated shape, in which the body 40 includes a first end 42 and a second end 44. The first end 42 includes a first opening 42a and the second end 44 includes a second opening 44a. In one exemplary embodiment, the size of the second opening 44a is less than the size of the first opening 42a. In another exemplary embodiment, the size of the second opening 44a is greater than the size of the first opening 42a. The first end 42 may include a threaded surface 42b that may be utilized to connect the body 40 to the nozzle 20. In one exemplary embodiment, the threaded surface 42b may be a male threaded surface that is configured to receive, i.e., mate with, the female threaded surface of the interior wall 26b of the nozzle 20 so as to securely fasten the body 40 to the nozzle 20.

A channel 46 extends from the first opening 42a of the first end 42 to the second opening 44a of the second end 44, such that an interior wall is formed within the body 40. For example, the channel 46 may be a through-hole, that transports fluid, e.g., water, from the second end 44 to the first end 42. The interior wall may include a surface that extends from the first opening 42a to the second opening 44a. In one exemplary embodiment, the entire surface of the interior wall may be smooth. In another exemplary embodiment, the interior wall may include a first interior wall portion and a second interior wall portion. The first interior wall portion may have a smooth surface, while the second interior wall portion may include a threaded surface. For example, the threaded surface may be utilized to connect the handle 10 to the hose. In one exemplary embodiment, the threaded surface may be a female threaded surface that is configured to receive, i.e., mate with, a male threaded surface so as to securely fasten the body 40 (and by extension the handle 10) to the hose.

In an exemplary embodiment, the channel 46 may include a disc or washer 50 that is disposed between the first interior wall portion and the second interior wall portion, such that a first interior space and a second interior space are formed. The first interior space extends from the first end 42 to a first side of the disc 50 and is enclosed by the first interior wall portion. The second interior space extends from the second 44 to a second side of the disc 50 (opposite to the first side of the disc 50) and is enclosed by the second interior wall portion. It should be noted that the disc or washer 50 may have a cross-sectional shape that is defined by the cross-section of the body 40. As such, the disc or washer 50 may not be limited to a curved cross-section. The disc 50 may include a disc opening, which may be for example, a through-hole that extends from the first side to the second side of the disc 50. In one exemplary embodiment, the disc opening may have a cross-sectional area that is less than the cross-sectional area of the first opening 42a and/or the second opening 44a. In another exemplary embodiment, the disc opening may be slightly offset from the circular cross-section of the channel 46, i.e., the disc opening is not concentric with the cross-section of the channel 46. In either of the aforementioned embodiments (or a combination of such aforementioned embodiments), when fluid enters the second opening 44a of the second end 44 into the second interior space, the disc 50 impedes the flow of the fluid as it flows from the second interior space into the first interior space via the disc opening. Such impediment increases the pressure of the fluid, which allows the efficient functioning of the one or more of the discharge modes.

In yet another exemplary embodiment, the body 40 may also include a valve 52, which allows the user to control the discharge of fluid from the body 40 and consequently the nozzle 20. The valve 52 includes a selection member 54 and a blocking member 56. The selection member 54 is connected to the blocking member 56, such that the manipulation of the selection member 54 causes movement in the blocking member 56. More specifically, the selection member 54 is movable between an open position and a closed position. In one exemplary embodiment, the selection member 54 is a knob that is capable of being manually rotated between the open position and the closed position. Selection member 54 is connected to the blocking member 56 such that movement or rotation of the selection member 54 also causes movement or rotation of the blocking member 56. Accordingly, the blocking member 56 is also movable between an open position and a closed position.

The blocking member 56 may be disposed within the first interior space of the channel 26. Further, the blocking member 56 may include a blocking wall 56a and an opening 56b. In one exemplary embodiment, the blocking member 56 includes a disc or washer shape. In such case, the blocking wall 56a forms the body of the washer 56, such that the blocking wall 56a includes an interior surface that forms the opening 56b and an exterior surface that is opposite the interior surface. It should be noted that the blocking member 56 is not limited to a washer or disc shape, as the cross-sectional shape of the blocking member 56 may conform to the cross-sectional shape of the body 40. Likewise the opening 56b is not limited to a curved shape, e.g., circle or oval, and may have a triangle, rectangular or polygonal shape. Further, the opening 56b may have another shape that may be different from the cross-sectional shape of the blocking member 56. For example, the blocking wall 56a may have a disc or washer shape, but the opening 56b is a triangle, rectangular or polygonal shape.

As shown in FIG. 11, when the blocking member 56 is in the open position, fluid entering the second opening 44a of the second end 44 is capable of traversing through the channel 44a and exiting via the first opening 42a of the first end 42 without any hindrance or obstruction. In the open position of the blocking member 56, the blocking wall 56a is unified with the first interior wall portion, such that the interior surface of the blocking wall 56b forms a continuous surface with the first interior wall portion. As such, the cross-section of the opening 56a may conform to the cross-section of the channel 46. For example, the cross-section of the channel 46 may include a circular shape with a predetermined radius. Consequently, to prevent hindrance or obstruction to the fluid flowing through the channel 46, the cross-section of the opening 56a may also conform to the cross-section of the channel 46 by, for example, having the same circular shape as well as the same predetermined radius. Alternatively, the opening 56a may also include a different shape or include a predetermined radius that is greater than the predetermined radius of the channel 46, so as to impede (but not completely obstruct) the fluid flowing through the channel 46. Such impedance may cause the pressure of the fluid to increase, which is advantageous for one or more of the discharge modes of the nozzle 20.

It should be noted that the first interior wall portion may include a space or an opening to accommodate the blocking wall 56b when the blocking member 56 is in the open position, so as to allow the interior surface of the blocking wall 56b to form a continuous surface with the first interior wall portion. For example, the space or opening of the first interior wall portion may correspond to the thickness of the blocking wall 56a, i.e., the distance between the interior surface of the blocking wall 56a and the exterior surface of the blocking wall 56a. In addition, the space or opening of the first interior wall portion may also correspond to the length of the blocking wall 56a. In short, the space or opening within the first interior wall portion is configured to account for the dimensions of the blocking wall 56a (and by extension the blocking member 56).

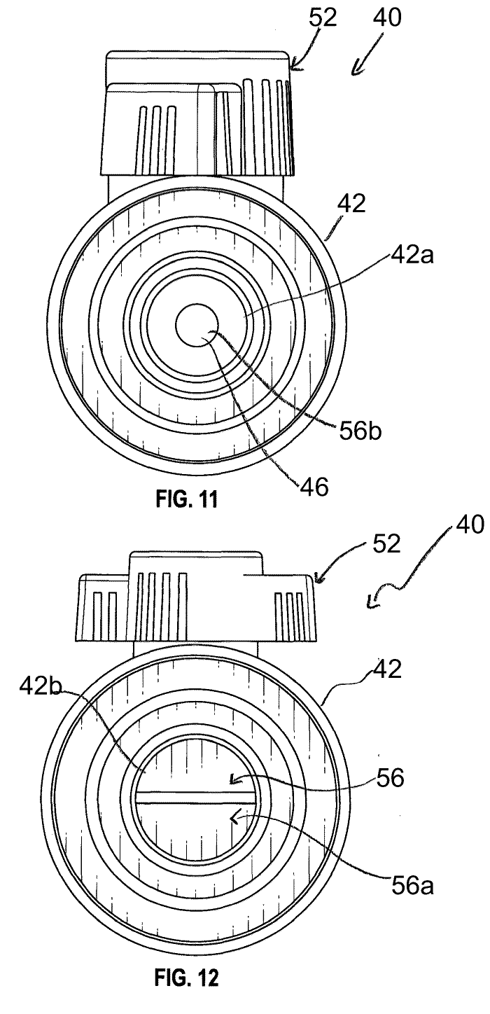

As shown in FIG. 12, when the blocking member 56 is in the closed position, the blocking wall 56a blocks the channel 46, thereby generating a fluid-tight seal, e.g., liquid-tight seal or water-tight seal. In other words, it is not possible for any fluid that is entering from the second opening 44a to exit via the first opening 42a and into the nozzle 20 for discharge. Indeed, such fluid remains in the handle 10, until it is released. In the closed position, the blocking wall 56a may be moved or rotated to a predetermined position. Such rotation is facilitated by the movement or rotation of the selection member 54. For example, the blocking member 56 (initially in the open position) rotates perpendicularly, i.e., 90 degrees, in order to progress to the closed position. When the blocking member 56 is in the closed position, the opening 56b is perpendicular to the channel 46 and the blocking wall 56a is parallel to the channel 46. This is in contrast to when the blocking member 56 is in the open position, in which the blocking wall 56a is perpendicular to the channel 46, while the opening 56b is parallel to the channel 46 (so as to allow fluid to pass through the channel 46 and exit from the first opening 42a).

The aforementioned feature of the valve 52 being included in the handle 10 is advantageous in that the user is provided with more convenience in operating the handle 10 than a conventional hose handle. Most conventional hose handles utilize a trigger mechanism, in which the user is required to continuously apply force to the trigger to maintain the discharge of fluid from the hose handle. To stop the fluid from discharging from the handle (such as because, e.g., the user is finished using the hose or the user wishes to move to another area for watering plants), the user releases the trigger, which causes the handle to end the discharge of fluid, such as through utilization and cessation of a spring mechanism. Nevertheless, it can be tiring for a user, especially for children or the elderly to continuously apply force to the trigger, because the spring mechanism may require a strong grip in order to maintain the discharge of fluid from the handle. Further, it is inconvenient to maintain a grip on the spring-loaded trigger for a continuous period.

As such, the valve 52 provides an advantage over such conventional hose handles in that the user merely utilizes the selection member 54 to determine whether to discharge fluid from the handle 10 or stop discharging fluid from the handle 10. In other words, the user merely moves or rotates the selection member 54, which does not require inclusion of a spring mechanism, in order to allow the discharge of fluid. Because it is a simple rotation due to the lack of a spring mechanism, the user is not required to exert a large amount of force to move the selection member 54 from the open position to the closed position, thereby enabling children or the elderly to more easily operate the handle 10. Further, as a result of being continuously in the closed position until the user moves the selection member 54 back to the open position, the user is not required to continuously maintain a grip or force upon the selection member 54, unlike with conventional hose handles. As such, the user is capable of focusing on the current task, e.g., watering plants or cleaning automobiles, without having to focus on continuously applying force upon the handle 10.

The aforementioned specific embodiments are illustrative, and many variations can be introduced on these embodiments without departing from the spirit of the disclosure or from the scope of the appended claims. In addition, elements and/or features of different examples, and illustrative embodiments may be combined with each other and/or substituted for each other within the scope of this disclosure and appended claims.

What is claimed is:

1. An adjustable handle comprising:
a body having a connecting member extending therefrom, a first end, a second end, and an interior channel extending from the first end to the second end;
a grip having a central opening and a cavity for receiving the connecting member of the body to connect the body with the grip; and
a grip position adjuster at least partially disposed in the cavity of the grip, the grip position adjuster including a button extending into the central opening of the grip,
wherein adjustment of the grip position adjuster by depressing of the button of the grip position adjuster permits rotational movement of the grip from being locked a first position to being locked in a second position.

2. The adjustable handle according to claim 1, wherein the grip position adjuster further includes one or more side protrusions capable of assisting the grip in locking in the first position or the second position.

3. The adjustable handle according to claim 1, wherein the first position of the grip is parallel to the channel of the body, and wherein the second position of the grip is perpendicular to the channel of the body.

4. The adjustable handle according to claim 1, wherein the second end of the body is configured for reversible connection to a hose capable of providing a fluid such the fluid traverses the body from the first end to the second end via the channel.

5. The adjustable handle according to claim 1, further comprising a nozzle that is reversibly attached to the first end of the body, the nozzle being configured to discharge a fluid that exits from the first end of the body.

6. The adjustable handle according to claim 5, wherein the nozzle includes one or more spray modes permitting a user of the adjustable handle to select a manner in which to discharge the fluid from the nozzle.

7. The adjustable handle according to claim 6, wherein the nozzle includes a rotational mechanism that allows the user of the adjustable handle to select the spray mode by operating the rotational mechanism.

8. The adjustable handle according to claim 6, wherein the nozzle includes one or more discharge openings that discharge the fluid according to the spray mode selected by the user.

9. The adjustable handle according to claim 1, wherein the body includes a valve that controls the flow of a fluid from the second end of the body to the first end of the body.

10. The adjustable handle according to claim 9, wherein the valve includes a selection member that is operable by a user of the adjustable handle to block the fluid from flowing from the second end of the body to the first end of the body.

11. A system for transporting a fluid, the system comprising:
a hose; and
an adjustable handle that is reversibly connected to the hose, the adjustable handle comprising:
a body having a connecting member extending therefrom, a first end, a second end, and an interior channel extending from the first end to the second end;
a grip having a central opening and a cavity for receiving the connecting member of the body to connect the body with the grip; and
a grip position adjuster at least partially disposed in the cavity of the grip, the grip position adjuster including a button extending into the central opening of the grip,
wherein adjustment of the grip position adjuster by depressing of the button of the grip position adjuster permits rotational movement of the grip from being locked a first position to being locked in a second position.

12. The system according to claim 11, wherein the grip position adjuster further includes one or more side protrusions capable of assisting the grip in locking in the first position or the second position.

13. The system according to claim 11, wherein the first position of the grip is parallel to the channel of the body, and wherein the second position of the grip is perpendicular to the channel of the body.

14. The system according to claim 11, wherein the second end of the body is configured for reversible connection to the hose such the fluid traverses the body from the first end to the second end via the channel.

15. The system according to claim 11, wherein the adjustable handle further comprises a nozzle that is reversibly attached to the first end of the body, the nozzle being configured to discharge the fluid that exits from the first end of the body.

16. The system according to claim 15, wherein the nozzle includes one or more spray modes permitting a user of the adjustable handle to select a manner in which to discharge the fluid from the nozzle.

17. The system according to claim 16, wherein the nozzle includes a rotational mechanism that allows the user of the adjustable handle to select the spray mode by operating the rotational mechanism.

18. The system according to claim 16, wherein the nozzle includes one or more discharge openings that discharge the fluid according to the spray mode selected by the user.

19. The system according to claim 11, wherein the body includes a valve that controls the flow of the fluid from the second end of the body to the first end of the body.

20. The system according to claim 19, wherein the valve includes a selection member that is operable by a user of the adjustable handle to block the fluid from flowing from the second end of the body to the first end of the body.
